(19) United States
(12) Patent Application Publication
(10) Pub. No.: US 2016/0247170 A1
(43) Pub. Date: Aug. 25, 2016

(54) System and Method for Determining, Visualizing and Monitoring Coordination of Resources

(71) Applicant: Northwestern University, Evanston, IL (US)

(72) Inventors: Nicholas D. Soulakis, Winnetka, IL (US); Matthew B. Carson, Chicago, IL (US); Denise M. Scholtens, Oak Park, IL (US)

(21) Appl. No.: 15/047,365

(22) Filed: Feb. 18, 2016

Related U.S. Application Data
(60) Provisional application No. 62/118,129, filed on Feb. 19, 2015.

(51) Int. Cl. G06Q 30/02

(52) U.S. Cl. CPC G06Q 30/0201; G06Q 50/22

(57) ABSTRACT

A system includes a processor and a memory, where the memory stores instructions, which when executed by the processor, causes the processor to extract providers and associated encounters from the memory, arrange providers and edges based on the encounters, and apply a weight to the edges to represent a strength of a relationship between the nodes.

### CROSS-REFERENCE TO RELATED APPLICATION

This application claims the benefit of U.S. Provisional Application Ser. No. 62/118,129, filed Feb. 19, 2015, which is incorporated in its entirety herein.

### GOVERNMENT LICENSE RIGHTS

This invention was made with government support under U18 HS20498 awarded by the Agency for Healthcare Research and Quality (AHRQ). The government has certain rights in the invention.

### BACKGROUND

Federal agencies, e.g., the Centers for Medicare and Medicaid Services (CMS) and the Agency for Healthcare Research and Quality (AHRQ), are working to promote care coordination across the nation in order to improve healthcare quality. While there may be uncertainty about the definition and proper measurement of care coordination quality, collaboration among a patient's numerous providers can help with its success. An NIH-funded report determines communication and collaboration between providers within and across institutions as two prerequisites to care coordination and concludes that effective collaboration can result in care coordination. In the past, quality measures have been developed to assess collaboration between physicians and nurses, and physicians and pharmacists, and also to evaluate the effectiveness of the programs designed to foster collaboration. The practice for measure development relies on a consensus from the scientific literature and domain experts. Implementing these approaches can be effective on the patient level, but may not reveal a comprehensive picture of care collaboration in a healthcare facility.

Approaches to measuring coordinated care include process measures for patient education, self-management, nutritional counseling, and follow up by telephone. Predominant approaches measure effects of these care coordination components through case study, analysis of reimbursement data or patient survey. A literature review of network analysis in healthcare studies showed that 50 of 52 studies used survey or observation to collect data, one study used physicians' order from the health information system (HIS), and one study utilized process logs. Manual data collection approaches may not be suitable for ongoing, systematic evaluation and furthermore lack comprehensive ascertainment of realized care coordination at healthcare facilities.

### BRIEF DESCRIPTION OF DRAWINGS

FIG. 1 is a flowchart of an example pipeline for processing resource data.

FIGS. 2A and 2B are graphs of an example provider-patient network for a patient node and a provider-only network for the same patient.

FIGS. 3A and 3B are graphs of example representations of the patient-sharing network.

FIG. 4 is a graph of example results of clique identification for the provider collaboration network in FIG. 3A.

FIG. 5 is a screenshot of a browser interface for the Neo4j graph database showing an example query for a subset of patients in the provider-patient network.

FIG. 6 is a property graph data model illustrating an example of activities performed by provider during encounters with two patients.

FIG. 7 illustrates an example collaboration evaluation strategy.

FIG. 8 is a plot of an example SPOR value distribution.

FIG. 9 is a plot of example statistics for SPOR values of collaboration networks.

FIG. 10 is a graph of an example provider collaboration network.

FIG. 11 is a property graph model showing a sample of activities performed by three providers during one encounter.

FIG. 12 is a graph of example results for satisfaction-based SPOR calculations in a provider collaboration network.

FIG. 13 is a graph of an example emergency department workflow and the providers who perform activities during workflow steps, colored by provider type.

### DESCRIPTION

The systems, methods and logic (referred to generally as systems and/or methods) can determine and monitor coordination of resources. For the sake of explanation the systems and methods are described in terms of health care, but the systems and methods can be used in other industries including but not limited to restaurants, law, construction (e.g., including ANGIE'S LIST and other list websites), e-commerce, etc. For the sake of explanation, in one example the systems and methods describe coordinated, collaborative, multidisciplinary electronic health record usage for hospitalized heart failure patients.

Coordinated, collaborative, multidisciplinary care can improve patient outcomes and decrease medical costs. Federal agencies including the Centers for Medicare and Medicaid Services and the AHRQ seek to increase coordinated care nationally as a way of improving healthcare quality. However, the ability to determine and measure coordinated care using electronic health records (EHRs) remains an elusive target for them. The AHRQ “Care Coordination Measures Atlas” suggests that care coordination measures depend on health information technology (HIT) systems that track data elements. Identifying the strategies to leverage HIT systems for ascertaining and monitoring care coordination is needed, e.g., in populations requiring a disproportionate share of healthcare spending in the United States, as is the case for heart failure patients at risk of readmission. The administrative data found within EHRs can be useful for managing identity and access, brought to light by the recent Strategic Health IT Advanced Research Projects initiatives funded by the Office of the National Coordinator for Health Information Technology. Clinical systems enable capture of EHR access by all users whether this access involves only browsing a record or updating it. This unique data source can identify out-of-the-ordinary record access by a variety of clinical and administrative actor types as well as use of clinical documentation.

Designed care coordination with determined multidisciplinary intervention teams can demonstrate positive effects on measures related to hospital readmissions for the chronically ill. However, top-tier healthcare providers respond to new challenges and innovate on a daily basis to create new patterns of care. To date, no study has presented a clear, reproducible method for discovering these spontaneous, contemporaneously assembled, and self-organized models of healthcare.

Graph theory and network analysis have been applied to a variety of large data sets in order to elucidate the nature and mechanisms of relationships in complex systems. For example, collaboration networks are graphs representing a social structure based on some type of shared interest. Recent bipartite networks model common activities among individuals and to describe collaboration networks in diverse settings from Broadway musicals to scientific paper authorship. This model can be applied to healthcare coordination within a hospital setting by creating a provider-patient directed bipartite network and extrapolating from this a provider collaboration network.

The systems and methods can ascertain and monitor care coordination by a graph-based analysis to identify healthcare interactions among populations known to suffer high readmission rates. In one example, collaborative electronic health record usage are visualized and described for the hospitalized heart failure patients.

Pipeline

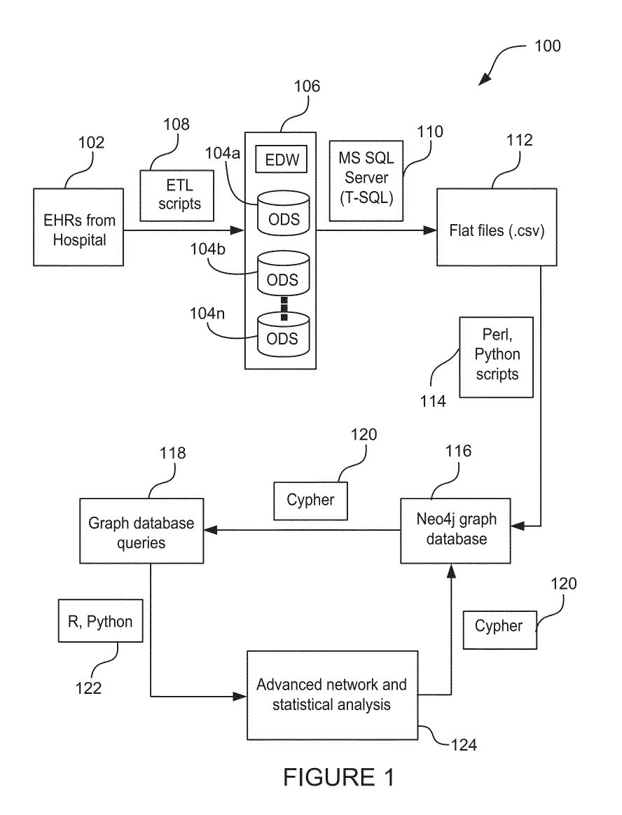

FIG. 1 is a flowchart of an example pipeline 100 for processing resource data. Information can be retrieved from electronic health records (EHRs) 102 of a hospital, or other entity, and transferred into one or more of an operational data store (ODS) 104a-n within an enterprise data warehouse (EDW) 106, e.g., using extract, transform, and load (ETL) scripts 108. A MICROSOFT Structured Query Language (SQL) Server (MS SQL) Management Studio (SSMS) 110, or other relational database management system, can be used to query and export the data set from the EDW 106 to comma separated value (.csv) files 112. The files 112 can be parsed and edited using scripts, e.g., written in Perl and Python, or other scripting language 114, to create input files for Gephi, or other visualization software, and Neo4j, or other graph database 116, for analysis. The Neo4j graph database queries 118 can be written using the native query language, Cypher, or other query language 120. The graph database queries 118 can output R and Python parameters 122 for advanced network and statistical analysis 124.

Provider and Patient Attributes

The pipeline 100 can collect the data from the 106, e.g., sets of attributes, for providers and patients. For providers, the pipeline 100 can extract employee ID, employee role, a physician index (e.g., 1 if provider is a type of physician, 0 if not), and/or other information. For patients, the pipeline 100 can extract age, encounter type (e.g., all ‘inpatient’ in this data set), admission and discharge times, primary diagnosis, discharge location, length of stay, medical service (e.g., department to which the patient was admitted), discharge disposition (e.g., where the patient was discharged to), an index noting whether or not the patient had expired, and/or other information.

From an analysis of queries of the information from the EDW 106, the pipeline 100 can identify heart failure patient records and all associated healthcare provider record usage. As described in more detail below, the systems and methods construct a network by equating access and updates of a patient electronic health record (EHR) to a provider-patient interaction. The systems and methods then consider shared patient record access as a basis for a second network referred to as the provider collaboration network. The systems and methods can calculate network statistics, the modularity of provider interactions, and provider cliques.

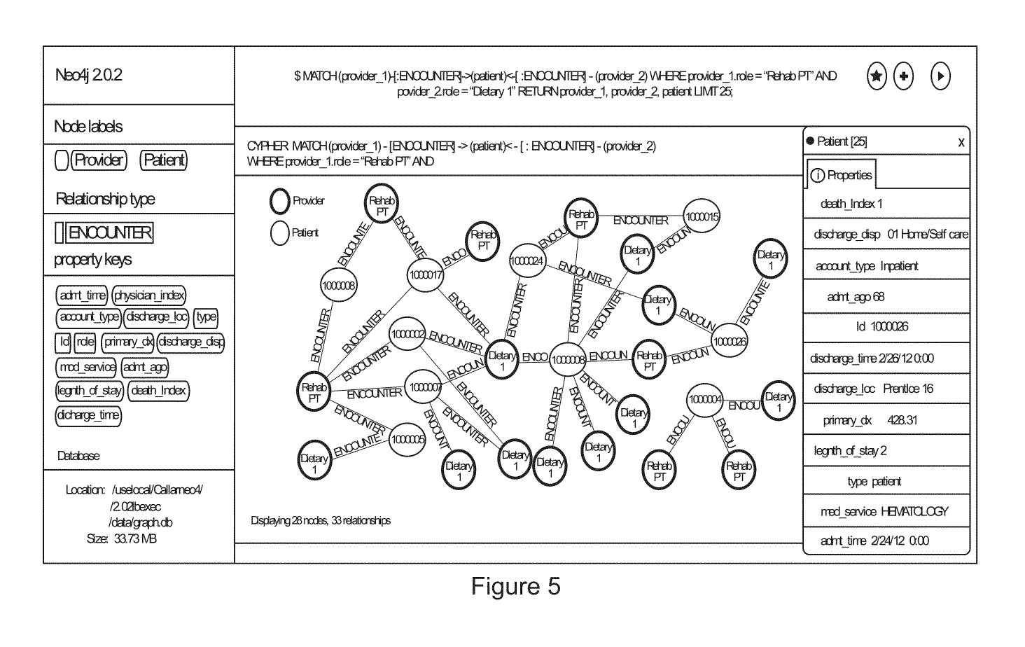

In one example, the pipeline 100 identifies 548 patient records accessed by 5,113 healthcare providers in 2012. The provider collaboration network has 1,504 nodes and 83,998 edges. The pipeline identifies 7 major provider collaboration modules. Average clique size is 87.9 providers. A Neo4j graph database demonstrates an ad hoc query of the provider-patient network (described more below in FIG. 5). Analysis can suggest a large number of healthcare providers across a wide variety of professions access a heart failure patient record during a hospital stay. This shared record access can take place not only in a pairwise manner but also among large groups of providers. EHRs 102 encode valuable interactions, implicitly or explicitly, between patients and providers. Network analysis provides evidence of multidisciplinary record access for heart failure patients across teams of 100+ providers. Record access information can be used to strategically guide care coordination for heart failure hospitalizations.

Network Visualization

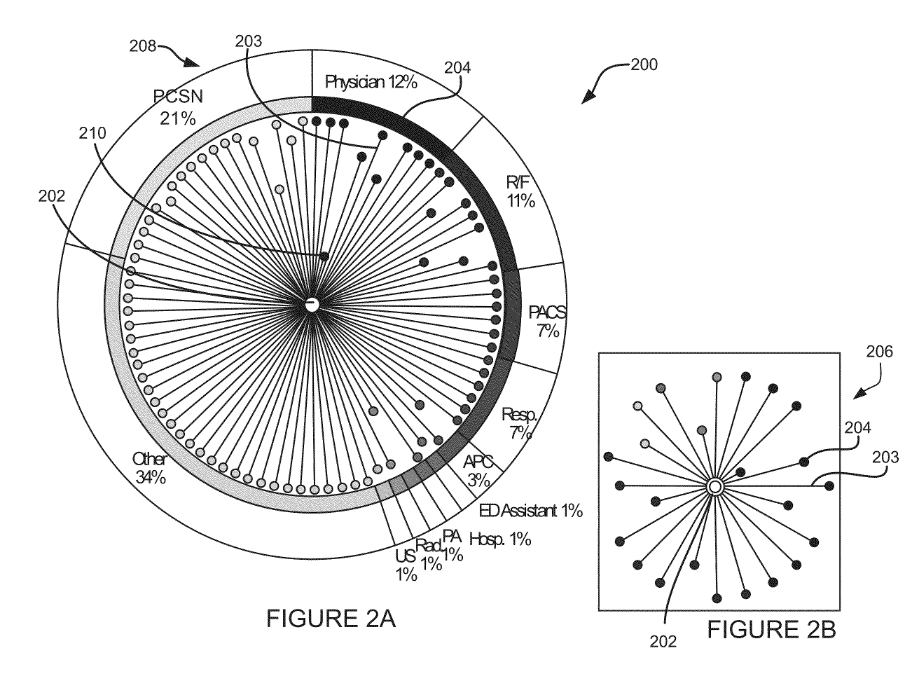

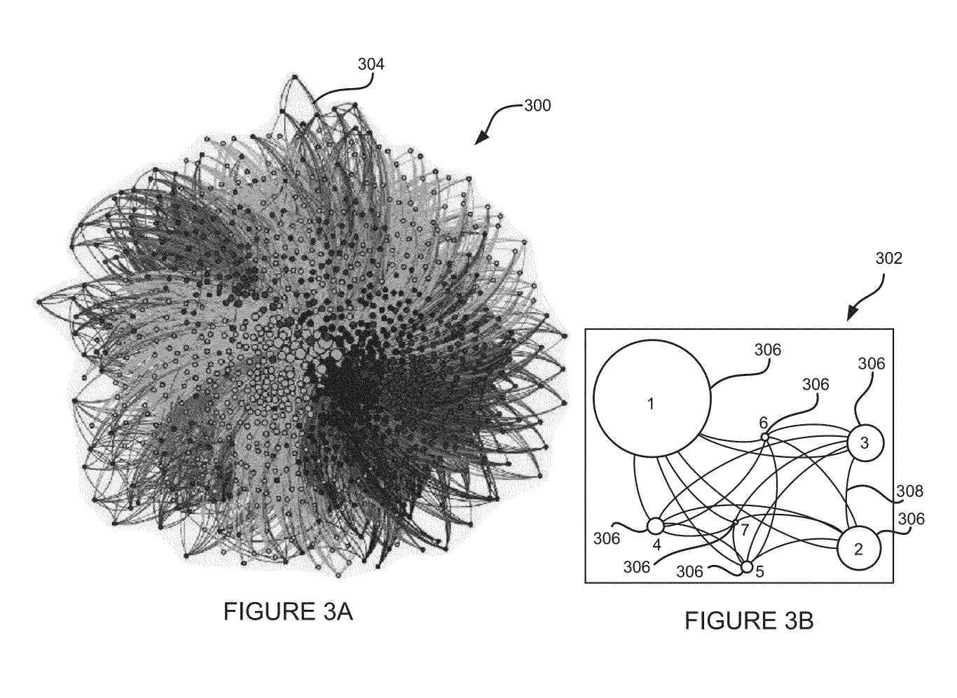

FIGS. 2A and 2B are graphs of an example provider-patient network 200 for a patient node 202 and a network 206 for the same patient. Network visualization can include a directed bipartite network that represents interactions between providers and patient records (FIG. 2A). Another network is undirected and depicts shared patient record access between providers (FIG. 3A). Visualization for both networks can be performed using Gephi.

For purposes of explanation, an example number of providers is 85; a number of order-placing providers is 15; other can include administrative staff and quality assurance; PCSN is patient care staff nurse; R/F is the hospital's (sometimes referred to herein as NMH) resident/fellow; PCAS is patient care assistive staff; Resp. is respiratory; APC is an advanced practice clinician; Hosp. is hospitalist; PA is a physician assistant; Rad. is a radiologist; and US is a unit secretary. An edge 203 connects a provider and the patient if the provider accessed the patient's record. Provider nodes 204 in closer proximity to the patient node 202 indicate that the provider placed a higher number of orders for the patient. In FIG. 2B, a network 206 for the same patient includes only providers designated as physicians (e.g., number of physicians is 24).

Provider-Patient Network

The bipartite graph in FIG. 2A depicts the shared record access for the patient with an average number of provider interactions (or average team size) and a typical length of stay. Source nodes designate a provider of type ‘physician’, ‘nurse’, ‘pharmacist’, etc. The target node 202 designates a patient with a diagnosis of heart failure who was admitted to the hospital in 2012. The edge 203 between the provider node 204 and the patient node 202 is an indication that the provider accessed the patient record. Provider nodes 204 and edges 203 can be colored and/or shaded by provider position and edge lengths indicate the number of orders (procedures, prescriptions, labs, or consultations) submitted by the providers. In an example, ‘shared record access’ for any given patient is determined as all providers who accessed his or her record. The complete provider-patient network included all providers as the set of source nodes and all patients as the set of target nodes. A pie chart 208 surrounding the network 200 describes a composition of the patient's care team based on each provider's position.

Provider Collaboration Network

An undirected provider collaboration network is developed using data recorded in the provider-patient network. Nodes in the provider collaboration network represent providers and edges represent pairwise shared access of at least 10 patient records. Other minimum number of records can be used. In one example, shared access of less than 10 records is excluded since omitting these edges removes potential noise and improved data consistency, and reduces the number of interactions within the network (from 2,217,570 edges to 83,998 edges) to make analysis more computationally feasible. Edges in the provider collaboration network can be weighted by a shared patient index (SPI)

$$SPI = \frac{\vert {PR}_{A} ⋂ {PR}_{B} \vert}{\vert {PR}_{A} ⋃ {PR}_{B} \vert} ,$$

where PRA is the set of patient records accessed by Provider A, PRB is the set of records accessed by Provider B, and 0≦SPI≦1. Also known as the Jaccard index, this statistic measures the similarity and difference between two sets. By adding an edge weight, some interactions are treated as being “stronger ties” than others. For example, the relationship between two providers who have a higher percentage of their total number of patient record accesses in common is stronger than the relationship between two providers who have less patient record accesses in common. This can accurately represent provider interactions than treating all relationships equally.

In FIG. 2B, the provider-patient network with only providers designated as physicians in the Cerner system. In this example, the physician-only network contains 24 providers compared to 85 in the comprehensive network. The provider node 210, closest to the patient, (position type ‘Physician’) was involved with placing a total of 58 orders. ‘Patient Care Staff Nurse’ was the position with the most individuals placing orders (n=4), while a provider of type ‘Physician’ placed the most orders for this patient. With regard to the comprehensive provider network, administrative and quality assurance staff (position type ‘Other’) made up 34% of the patient's care team and had the most patient record accesses. Following ‘Other’, ‘Patient Care Staff Nurse’ is the second most represented position, followed in order by ‘Physician’, ‘Resident/Fellow’, ‘Patient Care Assistive Staff’, and ‘Respiratory’. In some implementations, positions, e.g., ‘Respiratory’ and ‘Patient Care Staff Nurse,’ can include further differentiation. Excluding ‘Other’, this is roughly consistent with the median number of record accesses by position across the whole network, with the top five roles in order being ‘Patient Care Staff Nurse’, ‘Respiratory’, ‘Resident/Fellow’, ‘Patient Care Assistive Staff’, and ‘Pharmacist’ (see Table 1).

TABLE 1
published by the Journal of the American Medical Informatics Association

| | | | | Median | | Median |
|---|---|---|---|---|---|---|
| | | | | providers/ | Number | record |
| | | | Percent | patient | record | accesses |
| Position | Providers | Patients | patients | (min, max) | accesses | (min, max) |
| Patient Care | 940 | 543 | 99 | 12 (0, 123) | 9014 | 4 (1, 264) |
| Staff Nurse | | | | | | |
| NMH Resident/ | 654 | 522 | 95 | 9 (0, 95) | 7000 | 5 (1, 110) |
| Fellow | | | | | | |
| Med Student | 290 | 272 | 50 | 0 (0, 9) | 622 | 1 (1, 12) |
| NMH Physician | 262 | 494 | 90 | 3 (0, 28) | 2397 | 3 (1, 113) |
| Patient Care | 238 | 533 | 97 | 8 (0, 40) | 4662 | 10 (1, 170) |
| Assistive Staff | | | | | | |
| ED Patient Care | 170 | 324 | 59 | 1 (0, 15) | 762 | 2 (1, 62) |
| Staff Nurse | | | | | | |
| Respiratory | 107 | 546 | 100 | 12 (0, 67) | 8761 | 51 (1, 487) |
| Student Nurse | 101 | 155 | 28 | 0 (0, 8) | 395 | 2 (1, 20) |
| RAD - Technologist | 89 | 335 | 61 | 1 (0, 11) | 501 | 5 (1, 171) |
| RX-Pharmacist | 84 | 530 | 97 | 3 (0, 27) | 2567 | 19 (1, 263) |
| RAD - Nurse | 78 | 261 | 48 | 0 (0, 19) | 810 | 7 (1, 48) |
| RX-Pharmacy | 77 | 128 | 23 | 0 (0, 4) | 163 | 2 (1, 11) |
| Student | | | | | | |
| NMH Physician | 72 | 386 | 70 | 1 (0, 16) | 1332 | 16 (1, 77) |
| Hospitalist | | | | | | |
| RAD - Resident/ | 67 | 153 | 28 | 0 (0, 10) | 254 | 3 (1, 12) |
| Fellow | | | | | | |
| Advanced Practice | 61 | 327 | 60 | 1 (0, 15) | 983 | 5 (1, 106) |
| Clinician | | | | | | |
| RAD - Radiologist | 50 | 279 | 51 | 1 (0, 7) | 501 | 3 (1, 57) |
| NMH Anesthesia | 49 | 109 | 20 | 0 (0, 14) | 313 | 2 (1, 28) |

Table 1 provides patient-provider characteristics by position. ED=Emergency department; RAD=Radiology; NMH=Hospital. A summary of shared access statistics for the highly represented provider positions in the patient-provider network is shown in Table 1. ‘Providers’ indicates the count of providers in the position, ‘Patients’ is the number of patient records a provider of this type accessed, ‘Percent patients’ is the percentage of the previous value, ‘Median providers/patients (min, max)’ indicates the median, minimum, and maximum number of providers of this type who accessed a patient record, ‘Number record accesses’ is the total number of provider-patient relationships for a position in the network, and ‘Median patient record accesses (min, max)’ indicates the median, minimum, and maximum of the previous value. The top five most frequently observed provider positions made up 46% of the total positions: ‘Patient care staff nurse’ (n=940; 18%), ‘NMH Resident/Fellow’ (n=654; 13%), ‘Medical Student’ (n=290; 6%), ‘NMH Physician’ (n=262; 5%), and ‘Patient Care Assistive Staff’ (n=238; 5%). The position with the largest number of providers was ‘Patient Care Staff Nurse’ (n=940), and each interacted with a median of 12 patients. In contrast, the ‘Respiratory’ position had a total of 107 providers in the network but each provider interacted with a median of 12 patients. Table 1 identifies a total of 61,026 patient record accesses in the data set. Five provider positions accounted for 52% of these record accesses: ‘Patient care staff nurse’ (n=9,014; 15%), ‘Respiratory’ (n=8,761; 14%), ‘NMH Resident/Fellow’ (7,000; 11%), ‘Patient care assistive staff’ (n=4,662; 8%), ‘Rx-Pharmacist’ (n=2,567; 4%).

TABLE 2
published by the Journal of the American Medical Informatics Association,
provides multidisciplinary patient record sharing by provider position type

| | Any shared patient records | | | 10+ shared patient records | | |
|---|---|---|---|---|---|---|
| | | Total | Median | | Total | Median |
| | | collabo- | collaborations | | collabo- | collaborations |
| Position | Providers | rations | (min, max) | Providers | rations | (min, max) |
| Patient Care | 940 | 627026 | 516 (26, 3580) | 265 | 18645 | 33.5 (1, 819) |
| Staff Nurse | | | | | | |
| NMH Resident/ | 654 | 546923 | 721.5 (43, 2926) | 226 | 14544 | 25 (1, 443) |
| Fellow | | | | | | |
| Med Student | 290 | 90426 | 245.5 (24, 1319) | 2 | 9 | 4.5 (4, 5) |
| NMH Physician | 262 | 198237 | 550 (21, 3374) | 62 | 5867 | 44 (1, 593) |
| Patient Care | 238 | 229343 | 832 (26, 3096) | 121 | 9458 | 23 (1, 474) |
| Assistive Staff | | | | | | |
| ED Patient Care | 170 | 73086 | 261.5 (20, 2230) | 18 | 742 | 17.5 (1, 152) |
| Staff Nurse | | | | | | |
| Respiratory | 107 | 284029 | 2711 (146, 4960) | 92 | 34094 | 283 (3, 1391) |
| Student Nurse | 101 | 39627 | 315 (36, 1284) | 13 | 234 | 10 (1, 43) |
| RAD-Technologist | 89 | 74860 | 697 (79, 3944) | 25 | 920 | 4 (1, 756) |
| RX-Pharmacist | 84 | 137768 | 1709.5 (52, 4030) | 50 | 9852 | 128 (1, 918) |
| RAD-Nurse | 78 | 85682 | 1067.5 (71, 2848) | 32 | 1049 | 8.5 (1, 239) |
| RX-Pharmacy | 77 | 21537 | 216 (37, 1146) | 2 | 9 | 4.5 (1, 8) |
| Student | | | | | | |
| NMH Physician | 72 | 79627 | 18 (1, 179) | 48 | 1909 | 18 (1, 179) |
| Hospitalist | | | | | | |
| RAD-Resident/ | 67 | 39835 | 529 (66, 1605) | 4 | 16 | 3 (1, 5) |
| Fellow | | | | | | |
| Advanced Practice | 61 | 63908 | 204 (1, 334) | 23 | 3959 | 204 (1, 334) |
| Clinician | | | | | | |
| NMH Physician | 50 | 16828 | 238.5 (37, 1290) | 1 | 1 | 1 (1, 1) |
| Office | | | | | | |
| RAD-Radiologist | 50 | 40405 | 514.5 (47, 2623) | 14 | 1419 | 56 (5, 295) |
| NMH Anesthesia | 49 | 41016 | 614 (107, 2328) | 11 | 821 | 82 (1, 189) |

Multidisciplinary patient record sharing includes a collaboration type in which a provider shares patient records with another provider of a different position type. Table 2 summarizes collaborations across the entire network as well as those collaborations in which each provider shares at least 10 patient record accesses with another provider (described further in FIG. 2). For the comprehensive collaboration network, the top five positions with the highest median number of multidisciplinary collaborations per provider can be ‘Respiratory’ (n=2,711), ‘RX-Pharmacist’ (n=1,709.5), ‘RAD-Nurse’ (n=1,067.5), ‘Patient Care Assistive Staff’ (n=832), and ‘NMH Resident/Fellow’ (n=721.5). For the collaboration network with ≧10 shared patients, the top five positions in this respect are ‘Respiratory’ (n=283), ‘Advanced Practice Clinician’ (n=204), ‘RX-Pharmacist’ (n=128), ‘NMH Anesthesia’ (n=82), and ‘RAD-Radiologist’ (n=56). Despite a high number of multidisciplinary collaborations per provider in the comprehensive network, the ‘RAD-Nurse’ and ‘Patient Care Assistive Staff’ positions have relatively few multidisciplinary collaborations in the ≧10 shared patients network (8.5 and 23, respectively). ‘NMH Physicians’ and ‘RAD-Radiologists’ both had a relatively high number of multidisciplinary collaborations per provider in the 10 or more shared patients network and relatively few in the comprehensive network. Medical students, which had a relatively high total number of providers (n=290) and number of collaborations (n=90,426), in the comprehensive network had a low number of multidisciplinary collaborations in the ≧10 shared patients network (n=4.5).

FIGS. 3A and 3B are graphs 300, 302 of example representations of the patient-sharing network. Patient and provider node colors and/or shades can identify module membership. Edges 304 are assigned the color and/or shade of the source node. FIG. 3A is a network view in which nodes represent providers and edges between providers indicate ≧10 shared patient record accesses. The edge weight can be calculated using SPI described above. In FIG. 3B, a modular view illustrates nodes as groups of providers (modules) 306 and edges 308 between modules indicate patient record sharing between members of two modules, which can be weighted by total number of interactions between members. A total of seven modules 306 are identified, but other numbers of modules can be used depending on an implementation. In one implementation, by analyzing the weighting relationship between doctors, e.g., a better health care service can be provided and costs driven down.

Using the provider-patient network, a provider collaboration network can be constructed by identifying providers who accessed the same patient records (FIG. 2A). Nodes represent providers and an edge between two nodes indicates that these two providers accessed at least 10 common patient records. One-thousand five-hundred four providers are included in the example, approximately 29% of the 5,113 providers in the initial data set. The total number of edges was 83,998. Nodes can be sized according to degree (i.e., number of other providers with whom a provider has record accesses in common). Edges can be weighted using the shared patient index (see Methods section). The average node degree was ˜111, indicating a high level of collaboration between providers. Additionally, the average clustering coefficient value (0.882) reflects the strong tendency for pairs of collaborative physicians to also have other collaborative partners in common. However, the network density is quite low (0.074), indicating that there are many more possible collaborative interactions than exist in the real network.

Nodes and edges in FIG. 3A can be arranged using a two-step process. Initially, the systems and methods can apply the Force Atlas layout. The force-directed algorithm considers edge weights in determining the strength of a relationship between two nodes. A stronger relationship (larger edge weight) between two nodes results in a shorter edge length between them. Weaker relationships result in longer edge lengths. Next, the systems and methods can apply the Fruchterman Reingold layout, another force-directed algorithm implemented in Gephi. This layout does not use edge weights but instead attempts to distribute nodes evenly within the graph area, to allow as few overlapping edges as possible, and to make all edge lengths equal. A reason for the two-step process is that the output generated by force-directed algorithms is influenced by the initial layout. More or less steps can be used. By using the Force Atlas algorithm first, the systems and methods take into account edge weights and are able to group nodes by module (color and/or shade). The Fruchterman Reingold algorithm then modifies the output of the first algorithm by making the graph roughly symmetrical with edges of approximately equal length. In FIG. 3A, edges are assigned the same color and/or shade as the source node, and edge length is not connected to any attribute.

Module and Clique Identification

In FIG. 3B, sets of providers with high frequencies of pairwise shared record access can be identified using multiple approaches. One approach includes the heuristic community detection algorithm by Blondel et al. to identify sets of providers, or modules, with a higher density of edges within their set than outside the set. The algorithm can take into account edge weights and used randomization when identifying modules. The suggested resolution value of 1.0 is used. As before, edges are assigned the same color and/or shade as the source node. Edge width is tied to the number of inter-module interactions (shared record accesses between providers). A thicker edge indicates more interactions between providers in different modules (e.g., module 1 and 2 shared more inter-module provider interactions than 4 and 6).

As an example, the community detection system and methods identifies seven modules in a network and a network modularity value of 0.256. In FIG. 3B, the modular view of provider collaboration with provider nodes grouped by module and a total of 20 edges between them. Edges between modules are weighted by the total number of connections between members of two modules. The modules can be ordered by the number of providers belonging to each: module 1 (n=788), module 2 (n=237), module 3 (n=219), module 4 (n=106), module 5 (n=85), module 6 (n=43), and module 7 (n=26) (data not shown). Modules 1 and 2 have the most inter-module interactions, while only modules 6 and 7 shared no interactions. Among the 131 provider position types, 74 positions are represented in at least one module. ‘Patient Care Staff Nurses’ are included in each of the seven modules and they accounted for a high proportion of the providers in modules 3, 5, 6, and 7. Module 1 has the largest number of physicians (n=234), but module 6 has the highest percentage of physicians (33%). Hospitalists are present in modules 4 and 7 only and represent the largest percentage of any provider in module 4 (26%). ‘Respiratory’ are represented most prominently in module 2 (15%). Some modules show special compositions of positions, while module 1 includes at least one representative of most of the provider positions. Module 4 includes only emergency department physicians and nurses, and hospitalists. Module 6 contains a large proportion of radiology-related providers. Module 5 does not include any physician positions, while module 7 includes only one physician, an ‘Oncology Hospitalist’.

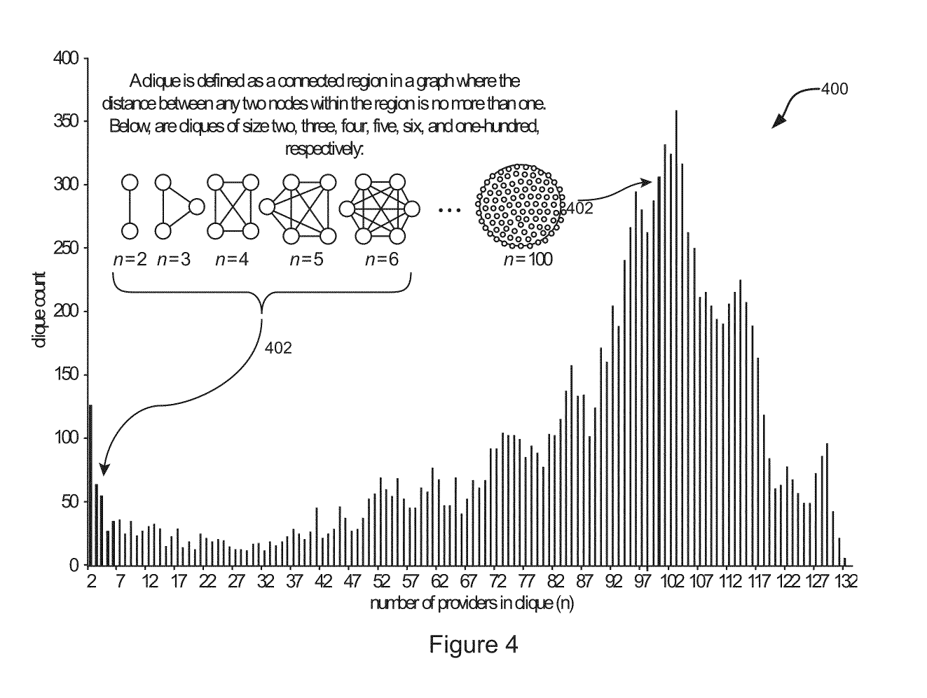

FIG. 4 is a graph 400 of example results of clique identification for the provider collaboration network in FIG. 3A. Clique identification can adopt a strict definition for shared record access by identifying all cliques in the data set. In one implementation, a clique is determined as the largest set of providers who shared record access with all other providers in the set. Whereas a single edge identifies shared record access between two providers, a clique reveals the extent of shared record access on a more global level. Clique membership and size within the provider collaboration network can be identified using the kCliques algorithm, part of the Boost Graph Library interface package (RBGL) for the R statistical computing environment. In FIG. 4, ‘Number of providers in clique (n)’, or clique size, is plotted against ‘clique count’, or the number of cliques of size n. Cliques are determined and illustrated in the upper left hand corner. Nodes represent providers and an edge between two providers indicates that they accessed at least 10 of the same patient records. The clique identification algorithm may not take the SPI edge weight into account. The red bars 404 indicated by the arrows designate the number of cliques of size 2, 3, 4, 5, 6, and 100 identified in the network. In one example, a total of 12,355 cliques are identified for 1,504 providers.

The clique detection algorithm was run on the network of healthcare providers sharing ≧10 patients. The number of cliques can be plotted by the number of providers in each clique in FIG. 4. A total of 12,355 cliques are identified for 1,504 providers. Clique membership is not exclusive; a provider may belong to more than one clique. This may be the case for the majority of the providers in this network (e.g., only 45% belong exclusively to one clique). For example, 37 providers can belong to 10,000 cliques or more. Each of these providers is designated a ‘non-physician’, with their specific position being ‘Patient Care Staff Nurse’, ‘Radiology Technologist’, ‘Respiratory’, or ‘Pharmacist’. The highest number of clique memberships is among providers in the ‘Respiratory’ position (12,338 cliques). The largest clique included 133 providers, while the average size was 87.9 providers and the median was 96. The results indicate that, in this particular collaboration network, many providers are closely connected, which implies that providers tend to collaborate with large groups of other providers as opposed to collaborating in smaller, tight-knit groups. It can be inferred from this analysis that providers in these positions tend to collaborate with many different groups of providers, illustrating a highly dynamic system of heart failure care. With 45% of providers belonging to only one clique, many tend to collaborate with a constant group of providers, despite what the high average node degree and clustering coefficient may suggest.

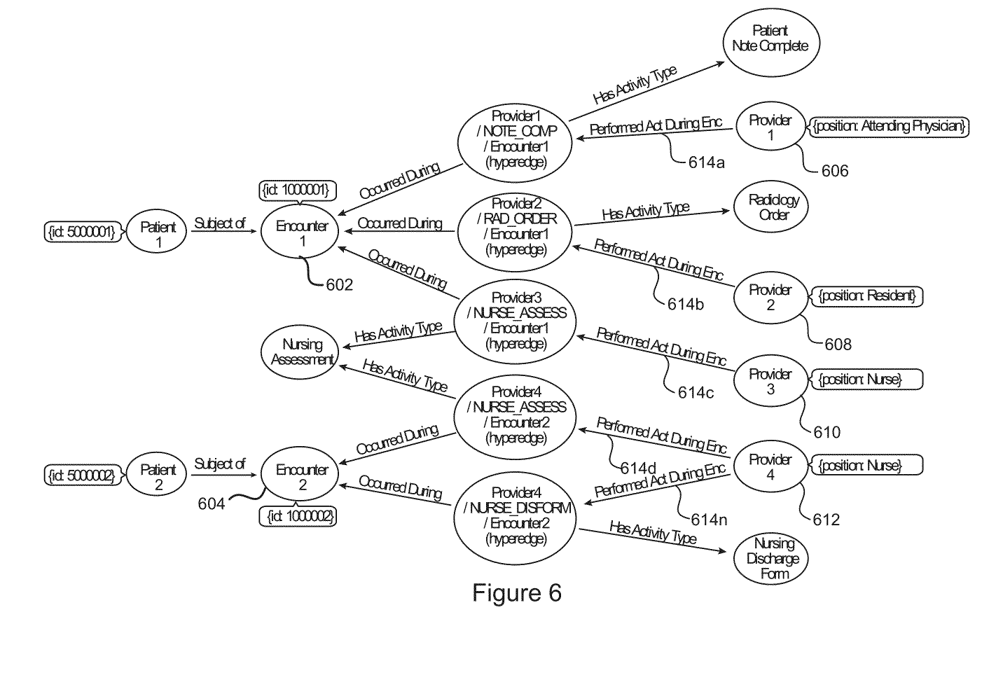

Classification rules generated from a decision tree analysis can query the provider-patient bipartite network using a graph database (for example, FIG. 6). The 26 patients who are identified by the rule can be associated with a total of 938 providers. There are 2,157 interactions between patients and providers, which can be termed ‘encounters’ in the database. The following Cypher query can be determined from the rule:

MATCH (provider_1)-[:ENCOUNTER]−>(patient)<−[:ENCOUNTER]-(provider_2)
WHERE provider_1.role = “Rehab PT”
AND provider_2.role = “Dietary 1”
RETURN provider_1,provider_2,patient;

This query returns 60 nodes and 107 relationships. FIG. 5 shows these results (de-identified and limited to 25 nodes for clarity). The characteristics of one patient are shown on the right (accessible by clicking on the node). The Neo4j graph database allows to extract information about this specific subset of patients for use in further analyses. Multiple relationship types can be specified as well. For instance, a relationship between providers based on shared patients can be created and displayed within the same query (not shown).

Querying the Provider-Patient Network

FIG. 5 is a screenshot 500 of a browser interface for the Neo4j graph database showing an example query for a subset of patients in the provider-patient network. Provider nodes are dark blue and patient nodes are blue-green. Directed edges are from providers to patients, indicating that a particular provider accessed a patient's record. Database information including node types, relationship types, and property keys (attributes) are shown on the left side. The query used to generate the subnetwork is shown at the top of the screen. The black box on the right lists the attributes of the highlighted patient node (circled in grey). This query identifies patients in the data set for whom providers in both the ‘Dietary 1’ and ‘Rehab PT’ positions accessed their record.

To facilitate the data mining of provider-patient and care collaboration networks, the database of patients, providers, and interactions can be built using the Neo4j graph database platform. A graph database combines the advantages of a traditional relational database with the high-performance capabilities of graph search methods. The database can be queried using a native query language (Cypher), or other language, e.g., SQL. Patient and provider properties mentioned above can be included. As a guide for conducting ad hoc queries of the graph database, several data mining packages can be used to partition the data set based on predetermined outcome measures such as mortality, intensive care unit (ICU) stay, or a length of stay >7 days. (e.g., R—rpart or WEKA—J48 decision tree). All provider position types can be entered as predictors and outcome measures can be used as target variables. The results from each tool can be compared to identify the best decision rules. Rules of interest are used to form Cypher queries. The Neo4j explorer interface is then used to further examine subnetworks.

Example Results

The initial data warehouse query provides a cohort of 695 distinct heart failure patients. After checking data quality and excluding readmissions, 548 heart failure patients can be identified meeting the study criteria. The average patient age was 65 years and the average length of stay was 8 days, with 374 patients (68%) discharged in 7 days or less. Twenty-one patients (4%) died and 153 patients (28%) can be in the ICU at some point during their hospitalization. 5,113 healthcare providers can be identified representing 131 unique positions. Fourteen hundred fifty-four (35%) providers can be physicians.

Multidisciplinary collaboration among healthcare professionals can occur daily throughout a hospital stay for heart failure patients. The case study of heart failure patients indicates that healthcare providers have a strong tendency to access healthcare records for common sets of patients, indicating likely collaboration with other providers. This collaboration tends to take place not only in a pairwise manner but also among large groups of providers, resulting in large, multifaceted teams of healthcare providers working implicitly (if not explicitly) together. The complexity of these data sets includes sophisticated and dynamic analysis methods to extract knowledge from the data that help both cut patient care costs and length of stay while improving the quality of patient care. This can be a first step in strategically guiding the organization of healthcare personnel by network analysis, e.g., by understanding the magnitude of actors and the complexity of their interactions.

EHRs encode valuable interactions, implicitly or explicitly, between patients and providers. Network analysis can provide strong evidence of multidisciplinary record access for heart failure patients across teams of 100+ providers on a daily basis. Investigation may lead to clearer understanding of how record access information can be used to strategically guide care coordination for heart failure hospitalizations.

Shared Positive Outcome Ratio (SPOR)

FIG. 6 is a property graph model illustrating an example of activities performed by provider during encounters with two patients. Providers 1, 2, and 3 each performed one activity during encounter 1, while provider 4 performed two activities during encounter 2. A hyperedge is used to represent an instance of activity during an encounter. Both Provider 3 and Provider 4 perform a ‘Nursing Assessment’ activity during different encounters. Without the hyperedges between the provider and the encounter nodes, it would not be possible to determine, for example, which provider performed the ‘Nursing Assessment’ during encounter 2.

Effective healthcare can include complex and interdisciplinary teamwork and shared patient encounters form the basis for collaborative relationships. Measuring these relationships by risk-adjusted patient outcomes provides insight into the collaborative interactions that occur between healthcare providers in a hospital setting and supplies a basis for identifying successful patient care teams in medicine. A network-based approach to quantify teamwork quality can characterize clinical processes, facilitate quality improvement (QI), and become an important tool in learning healthcare systems.

The systems and methods can determine a shared positive outcome ratio (SPOR) parameter that quantifies the concentration of positive outcomes between a pair of healthcare providers over a set of shared patient encounters. To evaluate the SPOR, a network model can assess pairwise collaboration using a test set of hospital emergency department patient visits over a determined time period, e.g., three-year, and there an outcome indicating the patient's satisfaction with their encounters. By comparing a collaboration network of hundreds of providers and thousands of relationships to a set of networks based on randomized outcomes, pairwise collaborations are identified having higher than expected patient satisfaction rates (p≦0.05). Results show that collaborative relationships between pairs of providers are not equal, that it is possible to identify extreme high- and low-scoring relationships over a set of shared patient encounters, and that, on a global level, collaboration between providers is highly variable in terms of patient satisfaction. In one example, tens of providers with ≧5% of their total collaborative relationships can be identified in the high-scoring group, indicating potential top performers in terms of patient satisfaction. More than half of these providers can have collaborations in both the high- and low-scoring groups, suggesting that individual providers have highly variable success rates when collaborating with colleagues. In addition, providers in the high-scoring group had both a larger average number of associated encounters and a higher percentage of total encounters with positive outcomes than those in the low-scoring group, implying that more experienced individuals may be better able to collaborate successfully. A healthcare collaboration network and the relationships it represents can be structurally evaluated to gain insight into the collaborative interactions that occur between healthcare providers in a hospital setting.

In contrast to a simple statistical approach to healthcare analysis that considers patient encounters as isolated events, a network approach of the systems and methods can consider the interdependency of encounters, the providers involved, and the effects these relationships have on each entity in the system. This context is used to examine the relationships formed between thousands of providers caring for patients in a hospital setting. In this frame of reference healthcare lies in the space of “organized complexity”, as Weaver called it; the problem is neither simple nor chaotic, but may lie somewhere between. A variety of definitions of and contexts for complexity have been purported over the years. The healthcare delivery organization and its associated activities can be determined in terms of a complex system, and the level of complexity determined by both the number of system components and the interdependencies between them.

The systems and methods determine characteristics, e.g., diversity, interdependence, connectivity, and adaptability. Several types of providers can be included, e.g., physician, nurse, radiation technician, etc., as well as patients with unique characteristics, e.g., age, preexisting conditions, condition at arrival, etc., making it highly diverse. Patient care by one provider can be dependent on how other providers supply care; each provider influences others in this sense. Further, many activities are performed by multiple providers, which contributes to interdependence. Providers and patients are connected through the care process, while providers are connected with each other through shared patients or activities and work in variable teams and shifts, with some exceptions such as surgical teams. The systems and methods can be adaptable, e.g., the loss or gain of a provider does not result in a hospital ceasing to function, and care protocols and activities can be added or removed with minimal effect on the system as a whole.

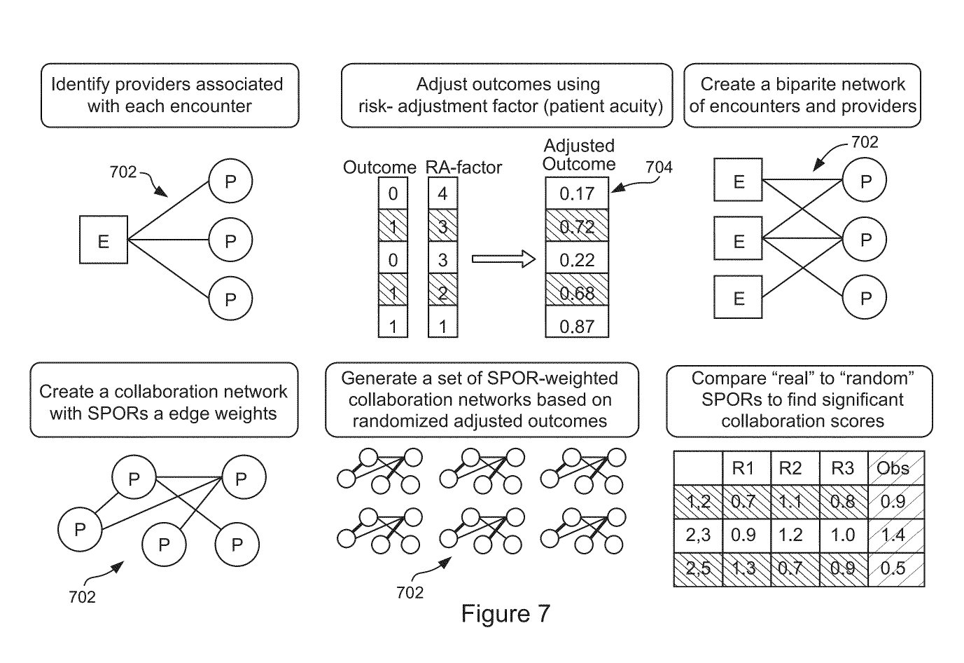

FIG. 7 is an illustration of the collaboration evaluation strategy. Taking into account patients, providers, encounters, and activities occurring during these encounters as components of a healthcare event, a logical relationship between the entities includes “Provider A performs Activity 1 for Patient P during encounter E”. Each provider performs one or more activities during an encounter and each sees multiple patients per day. In addition, many activities are performed during each encounter. The system increases in complexity as the number of patients, providers, and activities increases. Modeling this data to facilitate efficient searches and identify patterns can be a challenge. Because the components of a healthcare event are interconnected, a traditional relational data model may not scale well as the data set increases in size. A graph data model, however, can offer advantages. First, the nature of the model is such that all entities are logically connected through a variety of relationships. This inherent connectivity of all data results in faster query times relative to a relational model, which includes table joins in order to link different entity types, a process that quickly increases in computational time as joins are added. Second, the lack of a predetermined schema makes the graph data model flexible; updates and modifications do not include table alterations. Third, the labeled property graph model, a common variation of graph data model, allows properties to be added to both nodes and relationships. Nodes can also contain one or more labels. These features allow for a rich representation of the data and facilitate ad hoc querying of the associated database.

In graphs, edges, e.g., hyperedges 702, can be used to create a relationship between three or more entities. While using hyperedges 702 increases the size of the database and makes some query times slower, they can provide a couple of advantages. First, they identify a specific instance of an activity and allow us to identify the relationships between a provider, an activity, and an encounter. Each hyperedge 702 can relate the following: Provider P performed Activity A during encounter E. Second, hyperedges 702 add data flexibility in that they allow to identify subsets of activities and the providers who performed them. This can be useful in cases where examination of a specific activity group within a protocol is warranted, e.g., an analysis of all providers and activities associated with patient discharge.

Data of various types can be used in social network analysis (SNA) to construct affiliation networks. These often include two disjoint sets of entities, “actors” and “groups”, with a link indicating that an actor is associated with a group. From this bipartite network one can create a projection consisting of actor nodes with links between if they belong to one or more of the same group. Affiliation networks often focus on co-authorship and collaboration. Previous work has used SNA methods to analyze the professional networks of providers within healthcare systems. A small number of the studies attempt to identify targets for improving care coordination both on an organization- and patient-level. However, each of these studies is based on either a survey or direct observation. Most include small patient and provider samples, which may fail to capture larger trends in the healthcare system of interest. Some studies make use of larger data sets but focus only on interactions between physicians and other physicians or nurses and other nurses, which excludes many providers involved in day-to-day care. In addition, the majority use single-source commercial or Medicare claims data.

The CMS recognizes the importance of the electronic health record (EHR) as a rich resource for gathering information and promoting the coordination of care. Incentive programs are offered to encourage the meaningful use of EHRs. Though it can be difficult to use EHR data to construct an interaction map (or network) of providers and the patients they share, there are precedents for this in literature. As described above, EHRs can be used to effectively identify providers affiliated with a set of heart failure patients and subsequently demonstrated methods for visualizing and describing collaborative interactions among these providers who share common patients. The systems and methods extend these methods by developing an informative edge-weighting scheme, which allows for data-driven measurements of the relationships in a collaboration network. To monitor and improve healthcare quality, a weight imparts actionable information about the patients and providers involved.

The systems and methods can be used to understand, monitor, and improve provider collaboration by creating a highly adaptable, scalable, network-based platform that measures differences in working relationships between various providers. A generalizable, graph-based framework calculates and measures the shared positive outcome ratio (SPOR), an objective composite measure that quantifies the concentration of risk-adjusted positive outcomes for each pair of actors over a set of shared events. A flexible model can assess pairwise collaboration in terms of event outcomes given the frequency of collaboration between actors.

Materials and Processes

Quantifying and Measuring Collaboration: the Shared Positive Outcome Ratio (SPOR) The SPOR is a pairwise metric that quantifies the ratio of positive outcomes shared between two providers vs. positive outcomes shared with other providers. Components can include: a pair of providers, a set of outcomes for each shared encounter between them, an adjustment factor for weighting the contribution of each encounter to the SPOR metric, and a corresponding set of probabilities of the encounter outcomes given an optional set of baseline risk factors. While the systems and methods are described using the terms ‘provider’ and ‘encounter’ as appropriate for the application, the systems and methods can be adapted to other sets of events and actors.

Calculating Risk-Adjusted Outcome

The method can calculate ‘risk-adjusted’ outcomes 704. Let I be the set of encounters and J be the set of providers. For jεJ, let AⱼεI be the set of encounters involving j. Given an encounter iεI, the outcome related to this encounter, yᵢ, can be determined as

$${y}_{i} = \{ \begin{matrix}1 \to positive outcome \\ 0 \to negative outcome\end{matrix} \qquad ( 1 )$$

For a given set of potential risk factors, logistic regression can be used to confirm associations of the risk factors with the outcomes and to estimate probabilities of the outcomes given the data. If x₁ᵢ, x₂ᵢ, . . . xᵣᵢ are values of r risk factors for the patient involved in encounter i, let

$${p}_{i} = Pr ( {y}_{i} = 1 ) = \frac{{e}^{{β}_{0} + {β}_{1} {x}_{1 i} + {β}_{2} {x}_{2 i} + … + {β}_{r} {x}_{ri}}}{1 + {e}^{{β}_{0} + {β}_{1} {x}_{1 i} + {β}_{2} {x}_{2 i} + … + {β}_{r} {x}_{ri}}} \qquad ( 2 )$$

where the β parameters are estimated using logistic regression. Determine a risk-adjusted outcome, rᵢ, as follows:

$${r}_{i} ( {y}_{i} ) = \frac{1 + ( {y}_{i} - {p}_{i} )}{2} \qquad ( 3 )$$

Note that the expected value of rᵢ is:

$$E = {P}_{i} ( {Y}_{i} = 0 ) {r}_{i} ( 0 ) + {P}_{i} ( {Y}_{i} = 1 ) {r}_{i} ( 1 ) \\ E = {P}_{i} ( {Y}_{i} = 0 ) \frac{1 + ( 0 - {p}_{i} )}{2} + {P}_{i} ( {Y}_{i} = 1 ) \frac{1 + ( 1 - {p}_{i} )}{2} \\ E = ( 1 - {p}_{i} ) \frac{( 1 - {p}_{i} )}{2} {+}_{i} \frac{{p}_{i} ( 2 - {p}_{i} )}{2} \\ E = \frac{1 - 2 {p}_{i} + {p}_{i}^{2} + 2 {p}_{i} - {p}_{i}^{2}}{2} \\ E = \frac{1}{2} \qquad ( 4 )$$

Note the nature of the values of rᵢ given values of yᵢ and pᵢ:

$${y}_{i} = \{ \begin{matrix}1 , & high {P}_{i} \to {r}_{i} is close to 0.5 \\ 0 , & high {P}_{i} \to {r}_{i} is close to 0 \\ 1 , & low {P}_{i} \to {r}_{i} is close to 1 \\ 0 , & low {P}_{i} \to {r}_{i} is close to 0.5\end{matrix} \qquad ( 5 )$$

This has the effect of generously rewarding unexpected good outcomes (rᵢ close to 1) and heavily penalizing unexpected bad outcomes (rᵢ close to 0) while giving smaller rewards and penalties for expected outcomes (both close to 0.5). The intent of this risk adjustment is to account for variability in the characteristics of shared events between actors and should be informed by domain experts when the SPOR model is applied.

Deriving the SPOR

Let K⊂J×J be the subset of provider pairs (j, j′) such that A(j)∩A(j′)≠0.

The SPOR is a ratio of two indices. The first, referred to as the shared encounter index (SEI), is intended to measure the frequency of two providers being involved in the same encounters independent of outcome. Modeled after the Jaccard index, this statistic can be determined as follows:

$$SEI = \frac{\vert {A}_{j} ⋂ {A}_{k} \vert}{\vert {A}_{j} ⋃ {A}_{k} \vert} \qquad ( 6 )$$

where Aⱼ and Aₖ are the sets of patient encounters involving providers j and k, respectively. The second, termed the shared positive outcome index (SPOI), measures the ratio of outcomes for encounters shared by two providers relative to outcomes for all encounters involving either provider. The SPOI is determined as:

$$SPOI = \frac{{\sum }_{A ( j ) ⋂ A ( {j}^{′} )} {r}_{i} ( y ( i ) )}{{\sum }_{A ( j ) ⋃ A ( {j}^{′} )} {r}_{i} ( y ( i ) )} \qquad ( 7 )$$

The ratio of the SPOI and the SEI summarizes the observed risk-adjusted outcomes for encounters shared by two providers, relative to the expected outcomes:

$$SPOR = \frac{{\sum }_{A ( j ) ⋂ A ( {j}^{′} )} {r}_{i} ( y ( i ) ) / {\sum }_{A ( j ) ⋃ A ( {j}^{′} )} {r}_{i} ( y ( i ) )}{{\sum }_{A ( j ) ⋂ A ( {j}^{′} )} E ( {r}_{i} ( x ) ) / {\sum }_{A ( j ) ⋃ A ( {j}^{′} )} E ( {r}_{i} ( x ) )} \qquad ( 8 )$$

This pairwise measurement of the strength of an encounter-sharing relationship attempts to answer the following question for any pair of providers: How many more good outcomes do these two providers achieve when they work together versus when they work with other providers? For each provider, the “concentration” of good outcomes with each collaborator is measured.

Testing the Method with Clinical Data

Data Processing Overview

Referring again to FIG. 1, a multi-step process can be used to generate the data set to test the method. A graph data model can be built to represent providers, activities, and associated encounters. Second, patient encounter data can be extracted from electronic health records. For each encounter, from the set of all activities, a list of all healthcare providers who performed these activities can be identified and extracted, and a list of attributes associated with each entity type. In addition, an outcome can be identified and an acuity measure used for risk-adjustment modeling of the encounters. After acquiring the initial data set, the raw data can be processed and organized by checking for consistency and logic, dealing with missing values (e.g., IDs, position titles, activities, etc.), and omitting patient encounter records with inconsistencies. Using the parameters determined in the graph data model, the cleaned set can be loaded into a graph database, which served as a data repository and a query engine for analysis. Next, a provider-encounter network can be created and used this to identify providers who shared encounters. From this bipartite network one-mode projections can be created, termed provider collaboration networks. The SPOR can be determined, e.g., calculated, for each pairwise relationship and set this as the edge weight. Finally, statistical analysis can be performed on the networks. An overview of the data processing pipeline 100 is illustrated in FIG. 1. Additional details are given below.

Example Software Used

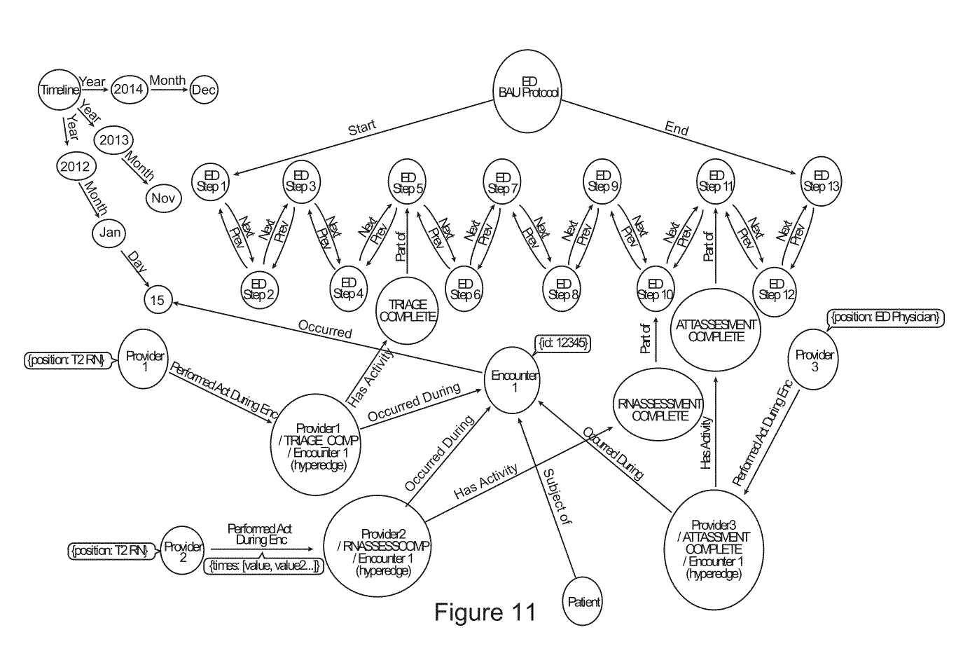

Patient encounter, provider, and activity data can be extracted from Cerner's FIRST NET software, an EHR system used by the emergency department, via extract, transform, and load (ETL) scripts and stored in operational data stores (ODSs) by the hospital's Enterprise Data Warehouse (EDW), a repository for electronic health record data. T-SQL queries from Microsoft SQL Server Management Studio can be used to export the raw data set to comma separated value (.csv) files. The Neo4j graph database management system can be used to create the data repository for the analysis and Cypher (Neo4j's native query language) to query the database. Data can be accessed and extracted from the database using Python and the Py2neo library. Python's NetworkX package can be used to create and analyze the networks and calculate the SPOR. R to perform statistical analysis and calculate risk-adjustment factors. Cypher can be used to update the graph database with data generated by the analyses. The graph data model example in FIGS. 6 and 11 can be created using the Arrows Tool (e.g., found at https://github.com/apcj/arrows).

The Graph Data Mode

In FIG. 6, linking patient data elements stored in the EHR to each activity type can identify the actions performed by each provider during each encounter. Once this information is gathered, it can be translated into a labeled property graph model. A simplified example of the graph model for two encounters 602, 604 and four providers 606, 608, 610, 612. Hyperedges 614a-n identify instances of provider activities. This allows to identify the relationships between a provider 606, 608, 610, 612, an activity 614a-n, and an encounter 602, 604. Hyperedges 614a-n also enable data subsetting and filtering. For example, the SPOR metric can be calculated for providers 606, 608, 610, 612 based only on clinical actions (leaving out administrative activity).

Providers 606, 608, 610 each performed one activity during encounter 602, while provider 612 performed two activities during encounter 604. A hyperedge 614a-n is used to represent an instance of activity during an encounter. In this example, both provider 610 and provider 612 perform a ‘Nursing Assessment’ activity during different encounters 602, 604. Without the hyperedges between the provider 606, 608, 610, 612 and the encounter nodes 602, 604, it may not be possible to determine, for example, which provider performed the ‘Nursing Assessment’ during encounter 604.

Data Set

In one example, the emergency department (ED) is a large, urban, academic facility with an annual volume of over 86,000 patients. Information can be retrospectively acquired from a subset of the electronic health records for patients who can be admitted to the ED between determined dates, e.g., Jan. 1, 2012 and Dec. 31, 2014 using the EDW. The final cleaned set includes 6,823 encounters of which 4,120 resulted in the patient indicating that they can be likely to recommend (LTR+) and 2,702 results in the patient being unlikely to recommend (LTR−). This set includes 2,750 providers, each being identified as holding one of 103 positions. The system identifies 1,696 unique activity types, which the system grouped into 16 categories. Each activity is one of four determined types: a clinical event, a requested action, a completed action, or an order. The activities are also identified as ‘administrative’ and ‘clinical’. Each provider performs one or more activities during each encounter, with each instance counted as a separate event. The data set included a total of 179,170 of these individual provider actions.

Evaluating Provider Collaboration

Using the theoretical framework determined above, the system measures and evaluates collaboration for a group of providers over a set of encounters. The evaluation process is summarized in FIG. 7. The first step can be to extract providers, associated encounters, and properties of each from the graph database. Next, the system calculates risk-adjusted outcomes using a logistic regression model. The system then creates a bipartite provider-encounter network with the risk-adjusted outcome as an encounter property. From this the system creates a provider collaboration network, calculates the SPOR for each relationship, and add the SPOR as an edge weight. The number of shared encounters between two providers is also stored as an edge property. During this process, the resulting collaboration network can be adjusted to include only those relationships between providers that exceeded a given threshold number of encounters. Subsequently, the system creates an adjacency matrix for this network in which each element corresponds to the SPOR of the collaborative relationship between two providers. The system then returns to the provider-encounter network and shuffle the risk-adjusted outcomes for each encounter using random sampling without replacement. Following the previous procedure, in one example, the system creates 1000 “random” collaboration networks followed by an adjacency matrix for each populated with SPOR values. The system compares each SPOR in the real network to SPORs for corresponding edges in each random network. See example, Table 3. The system then calculates a p-value for each pair of providers by identifying the number of times a SPOR value in a random network exceeds the SPOR value in the real network. The system classifies those collaborations with a p-value ≦0.05 as ‘high-scoring’ and p-value ≧0.95 as low-scoring′. For the high and low SPOR groups, the system identifies the number of times each provider was involved in these collaborations. Next, the system collects those providers for whom at least 5% of their total collaborative interactions can be included in the high- or low-scoring groups.

TABLE 3

| | Perm₀₀₀₁ | Perm₀₀₀₂ | Perm₀₀₀₃ | . . . | Permₓ | Obs | P-val |
|---|---|---|---|---|---|---|---|
| SPOR₁₂ | 0.984 | 1.30 | 1.15 | . . . | 1.07 | 1.09 | 0.21 |
| SPOR₁₃ | 1.09 | 1.05 | 0.782 | . . . | 1.11 | 1.37 | 0.01 |
| SPOR₂₂ | 0.996 | 0.913 | 1.03 | . . . | 0.859 | 1.04 | 0.35 |
| . . . | . . . | . . . | . . . | . . . | . . . | . . . | . . . |
| SPORₘₙ | 5.77 | 5.00 | 0.73 | . . . | 1.01 | 1.01 | 0.41 |

The SPOR value for each pairwise collaborative relationship from the real network was compared to the same relationship from each permuted network (those with collaborations based on randomized outcomes). ‘SPORxy’ indicates the SPOR value for the collaborative relationship between provider x and provider y. Collaborations with a p-value ≦0.05 (high-scoring) or p-value ≧0.95 (low-scoring) can be considered significant. An example of a significant score is row two.

The SPOR value for a collaborative relationship was highly volatile for those providers sharing few patients. Because of this, the system built a series of collaboration networks using an increasing threshold for the minimum number of shared patients included to constitute a collaborative relationship between a pair of providers and subsequently examined the distribution of SPORs across each network. This helps identify the threshold value that would generate a stable distribution and ensured that the score for each collaborative relationship was dependent a minimum number of events, which can make subsequent analysis more reliable.

Results

Collaboration Network

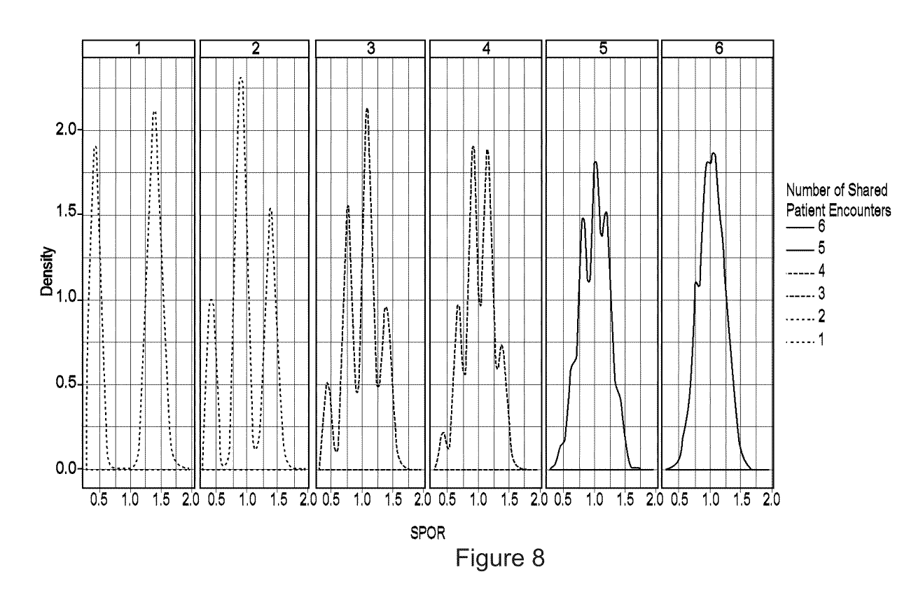

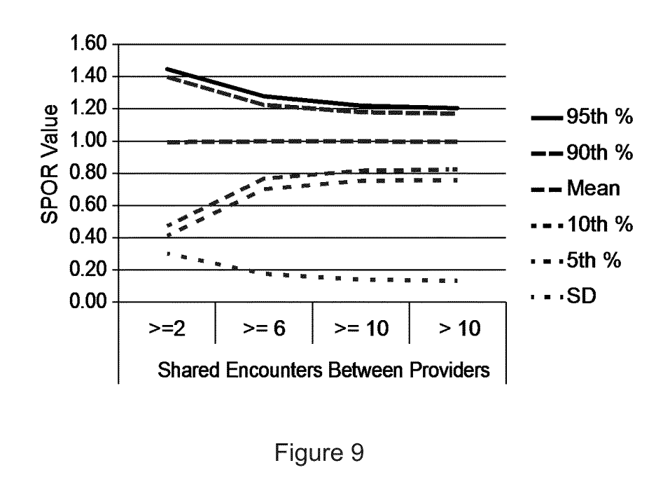

FIG. 8 is a plot of an example SPOR value distribution. The distribution of SPOR values across the provider collaboration network as the number of collaborations included between providers for inclusion into the network is increased. The distribution stabilizes when the lower limit on shared encounters is set a six. The system can create a set of collaboration networks, each with a different threshold on the number of shared encounters included to connect a pair of providers. The system can determine that the distribution of SPOR values moved closer to normal as the threshold was increased. The system identifies extreme SPOR values for four of these collaboration networks with the shared encounter threshold at ≧2, ≧6, ≧10, and ≧10. Table 4 and FIG. 9 provide summary statistics for these networks including the percentage of collaborative relationships in each network with high and low SPOR scores.

FIG. 9 is a plot of example statistics for SPOR values of collaboration networks. Each collaboration network includes an increasing threshold for the number of shared encounters between providers. As the number of shared encounters between providers was increased, the 90th and 95th percentiles slowly decreased, while the 5th and 10th percentiles slowly increased. The mean remains approximately constant, while the standard deviation decreased. This highlights the volatility in the low-threshold networks and demonstrates the need to set a minimum number of shared encounters. Because of this, the system performed all further analysis on the collaboration network requiring ≧6 shared encounters between providers.

TABLE 4
Statistics for four provider collaboration networks based an increasing
number shared patients included for a collaborative interaction.

| | Collaboration determined as a | | | |
|---|---|---|---|---|
| | working relationship between two | | | |
| | providers who share the | | | |
| | follow number of encounters. | | | |
| | ≧2 | ≧6 | ≧10 | >10 |
| | encounters | encounters | encounters | encounters |
| # providers | 1,479 | 580 | 359 | 325 |
| # | 54,030 | 5,642 | 1,327 | 1,007 |
| collaborations | | | | |
| # SPORs p-val | 2,880 | 295 | 63 | 49 |
| ≦0.05 | (5.3%) | (5.2%) | (4.7%) | (4.9%) |
| # SPORs p-val | 2,793 | 336 | 91 | 71 |
| ≧0.95 | (5.2%) | (5.9%) | (6.9%) | (7%) |
| 95th % | 1.44 | 1.28 | 1.22 | 1.20 |
| 90th % | 1.39 | 1.22 | 1.18 | 1.17 |
| Mean | 0.99 | 1.00 | 1.00 | 1.00 |
| 10th % | 0.47 | 0.76 | 0.82 | 0.82 |
| 5th % | 0.41 | 0.70 | 0.75 | 0.76 |
| SD | 0.30 | 0.18 | 0.14 | 0.13 |

As the shared patient threshold increased, the mean SPOR remained constant. The 5th and 10th percentiles increased as the threshold increased, while the 90th and 95th percentiles decreased. The standard deviation can decrease as well, indicating that the SPOR distribution was more stable for networks with a higher threshold.

To examine high- and low-scoring collaborative relationships more closely, the system can identify the providers involved with the largest number of these interactions. The system chooses those providers for which these high- or low-scoring collaborative interactions represented at least 5% of their total collaborative interactions in the network. Using this, in one example the system identifies 29 providers with multiple high-scoring collaborations, indicating potential top performers in terms of patient satisfaction (Table 5). The system found 38 providers with multiple low-scoring collaborations (Table 6). Fifteen providers belonged to both the high- and low-scoring groups. Interestingly, while the average number of high- or low-scoring collaborative relationships was similar across the two groups (8.03 and 8.26, respectively), the average number of total collaborations for the providers in the high-scoring group was larger. Providers belonging to the high-scoring group had an average of 6.6% of their total collaborations identified as significantly high scoring, while the average was 8.3% for the low-scoring group. Providers in the high-scoring group had both a higher average number of associated encounters (255 vs. 220) and a higher percentage of total encounters with positive outcomes (61% vs. 57%) than those in the low-scoring group. These could be indications that as providers gain more experience, their ability to form successful collaborations with other providers increases.

TABLE 5
High SPORs

| | | Collaboration Stats | | | Associated Encounter Stats | | |
|---|---|---|---|---|---|---|---|
| | | # | # | | | | % Encounters |
| Provider Info | | SPORs | collabs >=6 | | Pos | Total | w/Pos |
| DEID | Position | p-val <=0.05 | encounters | Percent | Outcomes | Encounters | Outcome |
| 9000578 | Radiologist | 17 | 311 | 5% | 333 | 523 | 64% |
| 9000465 | Radiologist | 14 | 293 | 5% | 330 | 513 | 64% |
| 9000728 | Radiology Tech | 15 | 281 | 5% | 249 | 411 | 61% |
| 9000120 | Radiologist | 15 | 266 | 6% | 270 | 435 | 62% |
| 9001032 | Medical Tech | 11 | 226 | 5% | 196 | 332 | 59% |
| 9000062 | Radiologist | 13 | 201 | 6% | 248 | 387 | 64% |
| 9000325 | ED Attending | 12 | 158 | 8% | 268 | 410 | 65% |
| 9001341 | Medical Tech | 8 | 151 | 5% | 135 | 242 | 56% |
| 9000343 | Physician Referral | 10 | 150 | 7% | 179 | 290 | 62% |
| 9000165 | Nurse | 5 | 126 | 4% | 170 | 312 | 54% |
| 9001699 | Medical Tech | 10 | 120 | 8% | 90 | 201 | 45% |
| 9001059 | Medical Tech | 6 | 115 | 5% | 115 | 205 | 56% |
| 9000385 | Medical Tech | 7 | 106 | 7% | 105 | 202 | 52% |
| 9000867 | Pharmacist | 5 | 105 | 5% | 115 | 194 | 59% |
| 9002700 | Laboratory Tech | 5 | 101 | 5% | 136 | 205 | 66% |
| 9000915 | Nurse | 7 | 90 | 8% | 152 | 251 | 61% |
| 9000320 | ED Attending | 8 | 88 | 9% | 166 | 263 | 63% |
| 9001036 | Medical Tech | 7 | 86 | 8% | 112 | 171 | 65% |
| 9000456 | Nurse | 5 | 84 | 6% | 151 | 229 | 66% |
| 9000679 | Nurse | 5 | 68 | 7% | 154 | 234 | 66% |
| 9000587 | Nurse | 5 | 61 | 8% | 111 | 223 | 50% |
| 9000018 | ED Attending | 6 | 60 | 10% | 137 | 199 | 69% |
| 9002390 | Medical Tech | 5 | 54 | 9% | 63 | 119 | 53% |
| 9000665 | Nurse | 6 | 50 | 12% | 114 | 169 | 67% |
| 9000859 | Laboratory Tech | 6 | 40 | 15% | 77 | 113 | 68% |
| 9001692 | Phlebotomist | 5 | 40 | 13% | 60 | 111 | 54% |
| 9000089 | Nurse | 5 | 37 | 14% | 108 | 164 | 66% |
| 9000163 | Nurse | 5 | 34 | 15% | 102 | 155 | 66% |
| 9002685 | Nurse | 5 | 22 | 23% | 77 | 125 | 62% |
| | Averages | 8.03 | 121.52 | 8% | 155.97 | 254.76 | 61% |

Twenty nine providers who have at least 5% of their total collaborative relationships in the highest 5% of SPOR scores (p-value ≦0.05). Fifteen providers are present in both the top 5% and the bottom 5% (see also Table 5). The number of associated encounters with positive outcomes and the total number of associated encounters for each provider are shown in the last three columns.

TABLE 6
Low SPORs

| | | Collaboration Stats | | | Associated Encounter Stats | | |
|---|---|---|---|---|---|---|---|
| | | # | # | | | | % Encounters |
| Provider Info | | SPORs | collabs >=6 | | Pos | Total | w/Pos |
| DEID | Position | p-val >=0.95 | patients | Percent | Outcomes | Encounters | Outcome |
| 9000578 | Radiologist | 20 | 311 | 6% | 333 | 523 | 64% |
| 9000465 | Radiologist | 15 | 293 | 5% | 330 | 513 | 64% |
| 9000728 | Radiology Tech | 15 | 281 | 5% | 249 | 411 | 61% |
| 9000120 | Radiologist | 13 | 266 | 5% | 270 | 435 | 62% |
| 9001032 | Medical Tech | 10 | 226 | 4% | 196 | 332 | 59% |
| 9000062 | Radiologist | 5 | 201 | 2% | 248 | 387 | 64% |
| 9000325 | ED Attending | 11 | 158 | 7% | 268 | 410 | 65% |
| 9001341 | Medical Tech | 8 | 151 | 5% | 135 | 242 | 56% |
| 9000165 | Nurse | 9 | 126 | 7% | 170 | 312 | 54% |
| 9001699 | Medical Tech | 15 | 120 | 13% | 90 | 201 | 45% |
| 9001059 | Medical Tech | 11 | 115 | 10% | 115 | 205 | 56% |
| 9000385 | Medical Tech | 9 | 106 | 8% | 105 | 202 | 52% |
| 9000867 | Pharmacist | 5 | 105 | 5% | 115 | 194 | 59% |
| 9002068 | ED Attending | 9 | 94 | 10% | 107 | 230 | 47% |
| 9001043 | Lab Coordinator | 6 | 92 | 7% | 100 | 195 | 51% |
| 9000320 | ED Attending | 5 | 88 | 6% | 166 | 263 | 63% |
| 9002532 | Medical Tech | 10 | 88 | 11% | 80 | 156 | 51% |
| 9000480 | ED Attending | 7 | 80 | 9% | 140 | 227 | 62% |
| 9001713 | Medical Tech | 5 | 78 | 6% | 92 | 173 | 53% |
| 9000065 | ED Attending | 6 | 75 | 8% | 142 | 227 | 63% |
| 9001181 | Physician Referral | 8 | 71 | 11% | 123 | 201 | 61% |
| 9000146 | Nurse | 7 | 67 | 10% | 121 | 210 | 58% |
| 9002390 | Medical Tech | 6 | 54 | 11% | 63 | 119 | 53% |
| 9001728 | Nurse | 10 | 53 | 19% | 83 | 166 | 50% |
| 9001653 | Medical Tech | 5 | 48 | 10% | 75 | 128 | 59% |
| 9000026 | Radiologist | 5 | 47 | 11% | 54 | 112 | 48% |
| 9000396 | ED Attending | 10 | 45 | 22% | 92 | 171 | 54% |
| 9000806 | Radiology Tech | 6 | 45 | 13% | 57 | 128 | 45% |
| 9000390 | ED Attending | 10 | 44 | 23% | 74 | 156 | 47% |
| 9001196 | Nurse | 6 | 42 | 14% | 82 | 168 | 49% |
| 9001394 | Resident/Fellow | 6 | 42 | 14% | 102 | 163 | 63% |
| 9001775 | Lab Coordinator | 5 | 30 | 17% | 67 | 118 | 57% |
| 9000095 | Nurse | 6 | 29 | 21% | 63 | 121 | 52% |
| 9000181 | Radiology Tech | 10 | 29 | 34% | 38 | 87 | 44% |
| 9000794 | Nurse | 5 | 27 | 19% | 78 | 141 | 55% |
| 9000310 | Nurse | 5 | 26 | 19% | 54 | 139 | 39% |
| 9001065 | Medical Tech | 5 | 25 | 20% | 57 | 99 | 58% |
| 9002718 | Laboratory Tech | 5 | 23 | 22% | 55 | 90 | 61% |
| | Averages | 8.26 | 100.03 | 12% | 126.03 | 219.87 | 57% |

Thirty eight providers who have at least 5% of their total collaborative relationships in the lowest 5% of SPOR scores (p-value ≧95%). Fifteen providers are present in both the top 5% (see also Table 4) and the bottom 5%. The number of associated encounters with positive outcomes and the total number of associated encounters for each provider are shown in the last three columns.

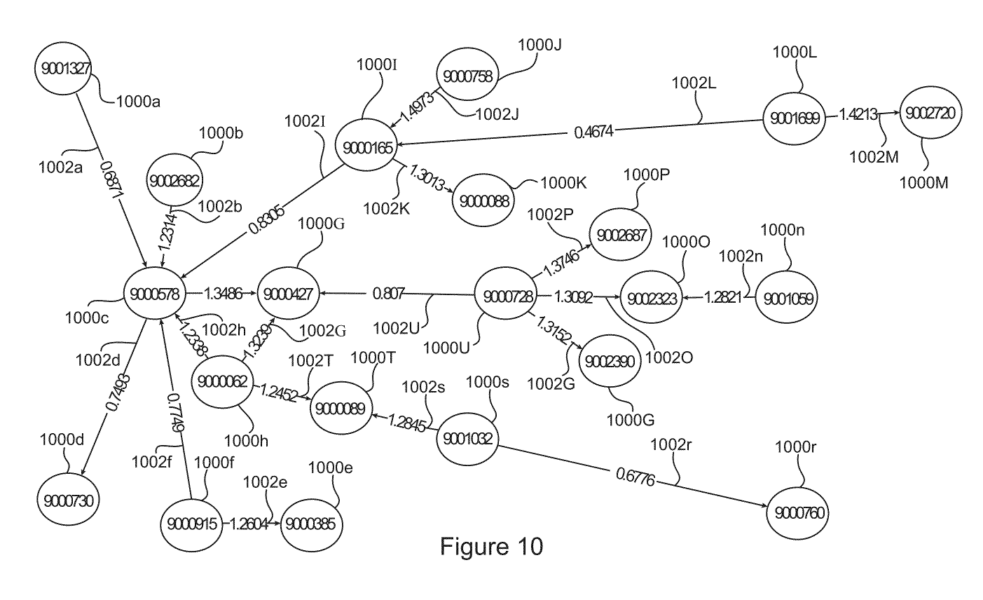

FIG. 10 is a graph of an example provider collaboration network. The example illustrates twenty-one providers 1000a-n and twenty-one SPOR 1002a-n relationships. Properties associated with edge 1002c include the SPOR coefficient, the number of shared patient encounters between the two providers (num_collabs), and an indication of the significance of the SPOR coefficient (p-value) is shown in the bottom left. The proximity of nodes to each other is based on the SPOR coefficient, with high-scoring relationships being shorter in length and low-scoring relationships being longer. The twenty-one providers 1000a-n are labeled by a randomized ID number. The twenty-one relationships shown between the providers are labeled with the SPOR value for the respective collaboration.

Descriptive Statistics for Test Data

Table 7 provides a summary of encounter-level statistics. The system found the average emergency department patient stayed approximately 4.5 hours and was given acuity level 3 (“Urgent”). An average visit involved nine providers, each of whom performed two to three activities. The length of stay, number of providers, number of actions, and the number activity types increased with acuity level from category 5 (Non-urgent) to category 1 (Resuscitation) (data not shown).

TABLE 7
Encounter-level statistics for the test data set.

| | | | Activity | Action | Provider |
|---|---|---|---|---|---|
| | LoS (hrs.) | Acuity | Count | Count | Count |
| Minimum | 0.22 | 1.00 | 2.00 | 2.00 | 1.00 |
| 1st Quart | 2.68 | 2.00 | 9.00 | 14.00 | 6.00 |
| Median | 4.03 | 3.00 | 15.00 | 23.00 | 8.00 |
| Mean | 4.53 | 3.04 | 16.06 | 25.35 | 9.18 |
| 3rd Quart | 5.73 | 4.00 | 22.00 | 34.00 | 11.00 |
| Max | 51.87 | 5.00 | 63.00 | 126.00 | 39.00 |
| St. Dev. | 2.76 | 0.77 | 8.38 | 15.2 | 4.31 |

A summary of encounter-level descriptive statistics showing length of stay (LoS) in hours, acuity, activity count (the number of times an activity type occurred), action count (the number of activity instances or provider actions), and the number of providers who performed at least one activity during the encounter.

The full provider-encounter network consisted of 2,748 providers and 6,823 encounters for a total of 9,571 nodes. The network contained 59,317 directed edges, where each directed edge from a provider to an encounter indicated that the provider performed at least one action during the encounter. The network density was 0.002, the average out-degree (the average number of provider-associated encounters) was 21.6, and the average in-degree (the average number of providers associated with an encounter) was 9.18.

### Discussion

Using the systems and methods, and an emergency department test data set, the system showed that, in terms of patient satisfaction, collaborative relationships between pairs of providers are not equal. Individual providers are often involved in both high- and low-scoring relationships. The results indicate that an increase in the number of shared encounters between a pair of providers may improve collaboration in some cases. Increasing the threshold for the minimum number of shared patient encounters between a pair of providers in the collaboration network resulted in a trend towards a normal distribution of SPOR values.

A healthcare collaboration network and the relationships it represents can be structurally evaluated to gain insight into the collaborative interactions that occur between healthcare providers in a hospital setting. Through analysis of this network, the system revealed previously unknown strengths, weaknesses, and patterns of interaction. Measuring collaborative relationships by risk-adjusted outcomes provided a relevant and informative basis for identifying successful patient care teams in medicine. Though the SPOR is designed to score pairwise collaboration, the graph database structure facilitates identification of high-scoring groups of providers through graph search methods (See FIG. 10).

The SPOR can be modified to measure collaboration between teams of three or more members. Information from additional sources could be added to enrich the network and improve its modeling capability. Further enrichment of the model would provide more effective recommendations for new care team members. Furthermore, by including outpatient or clinic data in addition to inpatient records, inter-facility collaborations could be more closely analyzed. Through further analysis of specific protocols and related activities, it is possible to find areas of excellence in collaboration as well as areas that can be targeted for improvement.

In other example, the test data set extracted from electronic health records can capture events such as cell phone and hallway conversations, text messages, personal conflicts, and other confounding factors that could potentially affect working relationships within a hospital environment. The systems and methods have been explained using data from one domain (Emergency Medicine), but analysis with data sets from other hospital departments can provide an informative comparison. Even though the system used a risk adjustment strategy, there may be other factors such as time of patient admission and daily provider caseload that can affect patient encounter outcomes.

Using the systems and methods, collaboration between providers can be highly variable in terms of patient satisfaction, and that it is possible to identify extreme high- and low-scoring relationships over a set of shared patient encounters. The system also highlight that a majority of providers are involved in both high- and low-scoring relationships, suggesting that collaboration can be also highly variable on an individual level.

FIG. 11 is a property graph model showing a sample of activities performed by three providers during one encounter. The activities performed by three providers during one encounter are shown. Nodes include: emergency department (ED) workflow, encounter, hyperedge, provider, time, and activity. Inherent connectivity of all data can yield to faster query times and avoids the “join problem”. A lack of a predetermined schema allows for easy updating and modification of the model; no table alterations included. In the labeled property graph model both nodes and relationships can have properties (key-value pairs); this creates a rich data representation and facilitates ad hoc queries. Hyperedges: Identify specific instances of an activity and allow relationships between n>2 entities (i.e., Provider P performed Activity A during encounter E). Add flexibility by allowing data subsetting, e.g., an analysis of all providers and activities associated with specific workflow steps.

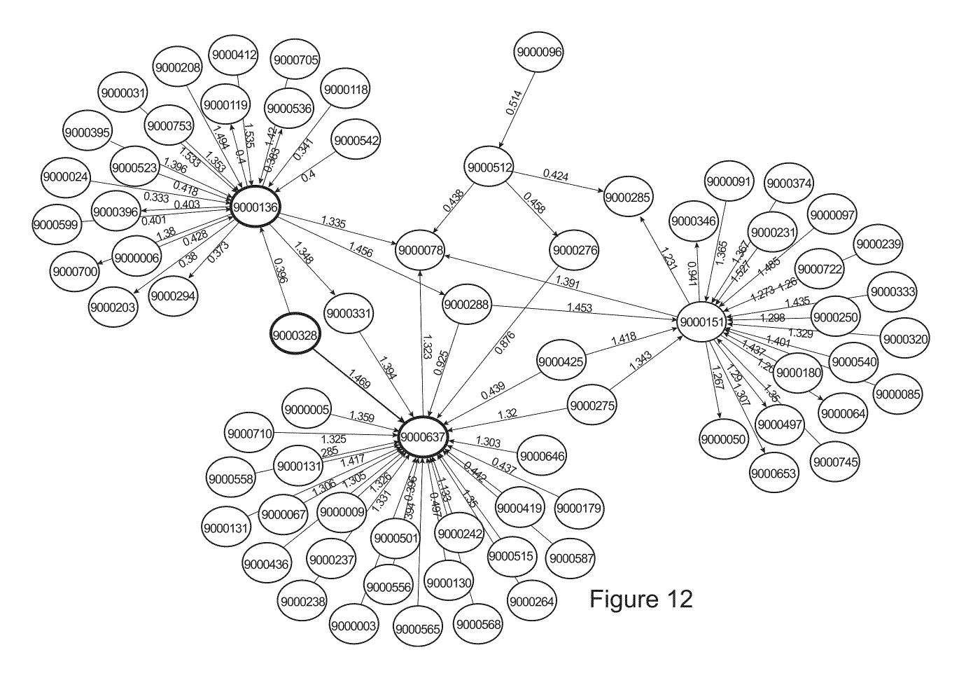

FIG. 12 is a graph of example results for satisfaction-based SPOR calculations in a provider collaboration network. As shown in FIG. 10, in terms of patient satisfaction, collaborative relationships between pairs of providers are not necessarily equal. Furthermore, individual providers are often involved in both high- and low-scoring relationships. Three provider nodes are highlighted in FIG. 12. The center provider has a high SPOR score for the relationship to the provider on the right (highlighted), but a low SPOR score for the relationships with the provider on the left. An increase in the number of shared encounters between a pair of providers may improve collaboration in some cases.

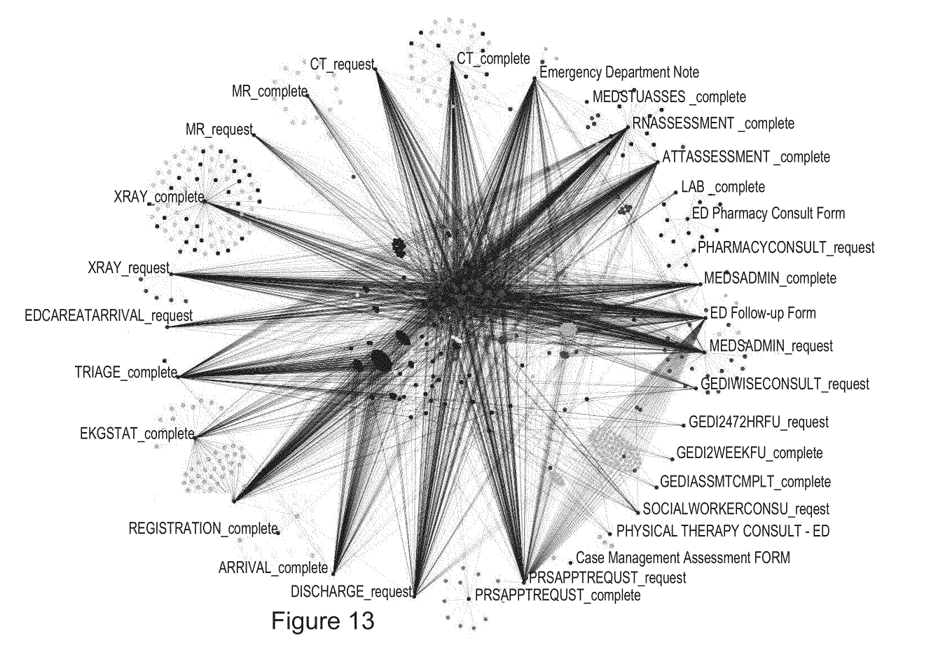

FIG. 13 is a graph of an example emergency department workflow and the providers who perform activities during workflow steps, colored by provider type. Activities in the ED workflow (clockwise from the bottom left in order of occurrence) and a subset of the providers who performed them. Protocol activities are labeled. Providers are colored and/or shaded by position type: Physician, Res/Fellow, Med Student, Nurse, ED assistant, Pharmacy, RAD, ED registration, Physician Referral Services (PRS), Reg/Sched SU. The number of activities performed varies widely across provider types, with nurses, physicians, and res/fellows carrying out the largest number of activity types. Some provider types (e.g., Nurse) are divided into sub-communities based on similar subsets of activities performed by individuals. See clusters of nodes towards the center of the Figure.

The systems and methods described above may be implemented in many different ways in many different combinations of hardware, software firmware, or any combination thereof. In one example, the systems and methods can be implemented with a processor and a memory, where the memory stores instructions, which when executed by the processor, causes the processor to perform the systems and methods. The processor may mean any type of circuit such as, but not limited to, a microprocessor, a microcontroller, a graphics processor, a digital signal processor, or another processor. The processor may also be implemented with discrete logic or components, or a combination of other types of analog or digital circuitry, combined on a single integrated circuit or distributed among multiple integrated circuits. All or part of the logic described above may be implemented as instructions for execution by the processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. A product, such as a computer program product, may include a storage medium and computer readable instructions stored on the medium, which when executed in an endpoint, computer system, or other device, cause the device to perform operations according to any of the description above. The memory can be implemented with one or more hard drives, and/or one or more drives that handle removable media, such as diskettes, compact disks (CDs), digital video disks (DVDs), flash memory keys, and other removable media.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

While various embodiments have been described, it can be apparent that many more embodiments and implementations are possible. Accordingly, the embodiments are not to be restricted.

We claim:

1. A system, comprising:
a processor and a memory, where the memory stores instructions, which when executed by the processor, causes the processor to:
extract providers and associated encounters from the memory;
arrange providers and edges based on the encounters; and
apply a weight to the edges to represent a strength of a relationship between the nodes.

2. The system of claim 1, further comprising distributing the nodes evenly.

3. The system of claim 1, further comprising correcting the edges based on relative volume.

4. The system of claim 1, where the provider comprises a doctor.

5. The system of claim 1, further comprising grouping the nodes into modules based on a number of edges.

6. The system of claim 1, further comprising comparing the modules to improve service.

7. The system of claim 6, where the service includes health care.

8. The system of claim 6, further comprising ordering the modules by a number of providers in the modules.

9. The system of claim 1, where the providers and edges are further arranged based on whether the encounter was a positive or a negative experience.

10. A system, comprising:
a processor and a memory, where the memory stores instructions, which when executed by the processor, causes the processor to:
extract providers and associated encounters from the memory;
calculate a risk-adjusted outcome using a logistic regression model;
create a bipartite provider-encounter network with the risk-adjusted outcome as an encounter property;
create a provider collaboration network from the bipartite provider-encounter network;
calculate a shared positive outcome ratio for relationships between the providers and the encounters in the provider collaboration network; and
add the shared positive outcome ratio as an edge weight for the relationships.

11. The system of claim 10, further comprising:
store a number of shared encounters between providers as an edge property.

12. The system of claim 10, further comprising:
adjust the provider collaboration network to include only those relationships between providers that exceeded a determined threshold number of encounters.

13. The system of claim 10, further comprising:
create an adjacency matrix for the provider collaboration network where the shared positive outcome ratio corresponds to a collaborative relationship between two providers.

14. The system of claim 10, where the memory comprises a graph database.

15. The system of claim 10, where a distribution of the shared positive outcome ratio stabilizes as a number of shared encounters to connect a pair of providers as a minimum threshold increases.

16. The system of claim 15, where the minimum threshold comprises six shared encounters.

17. The system of claim 10, where the provider comprises a doctor.
